(19) United States
(12) Patent Application Publication
(10) Pub. No.: US 2015/0334744 A1
(43) Pub. Date: Nov. 19, 2015

(54) LOAD BASED LTE/LTE-A WITH UNLICENSED SPECTRUM

(71) Applicant: QUALCOMM Incorporated, San Diego, CA (US)

(72) Inventors: Tingfang Ji, San Diego, CA (US); Aleksandar Damnjanovic, Del Mar, CA (US); Gavin Bernard Horn, La Jolla, CA (US); Yongbin Wei, La Jolla, CA (US); Durga Prasad Malladi, San Diego, CA (US); Naga Bhushan, San Diego, CA (US); Hao Xu, San Diego, CA (US); Wanshi Chen, San Diego, CA (US); Tao Luo, San Diego, CA (US); Kiran Kumar Somasundaram, San Diego, CA (US)

(21) Appl. No.: 14/712,010

(22) Filed: May 14, 2015

Related U.S. Application Data
(60) Provisional application No. 61/993,861, filed on May 15, 2014.

(51) Int. Cl. H04W 74/08; H04L 1/00; H04L 5/00; H04W 74/00

(52) U.S. Cl. CPC H04W 74/085; H04W 74/002; H04L 1/0008; H04L 5/0007

(57) ABSTRACT

In one aspect of the disclosure, a method of wireless communication includes receiving, at a transmitter, data for transmission over an unlicensed carrier, calculating, at the transmitter, a first available extended clear channel assessment (ECCA) opportunity of the unlicensed carrier after the receiving, wherein the calculating uses at least network information and a pseudo-random number, performing a clear channel assessment (CCA) check, by the transmitter, on the unlicensed carrier at the first available ECCA opportunity, in response to detecting a clear CCA check, transmitting channel reserving signals, by the transmitter, onto the unlicensed carrier, and in response to failing to detect the clear CCA check, calculating, by the transmitter, a next available ECCA opportunity of the unlicensed carrier using at least the network information and another pseudo-random number.

### CROSS-REFERENCE TO RELATED APPLICATIONS

This application claims the benefit of U.S. Provisional Patent Application No. 61/993,861, entitled, “LOAD BASED LTE/LTE-A WITH UNLICENSED SPECTRUM,” filed on May 15, 2014, which is expressly incorporated by reference herein in its entirety.

### BACKGROUND

1. Field

Aspects of the present disclosure relate generally to wireless communication systems, and more particularly, to load based long term evolution (LTE)/LTE-Advanced (LTE-A) with unlicensed spectrum.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

In one aspect of the disclosure, a method of wireless communication includes receiving, at a transmitter, data for transmission over an unlicensed carrier, calculating, at the transmitter, a first available extended clear channel assessment (ECCA) opportunity of the unlicensed carrier after the receiving, wherein the calculating uses at least network information and a pseudo-random number, performing a clear channel assessment (CCA) check, by the transmitter, on the unlicensed carrier at the first available ECCA opportunity, in response to detecting a clear CCA check, transmitting channel reserving signals, by the transmitter, onto the unlicensed carrier, and in response to failing to detect the clear CCA check, calculating, by the transmitter, a next available ECCA opportunity of the unlicensed carrier using at least the network information and another pseudo-random number.

In another aspect of the disclosure, an apparatus configured for wireless communication includes means for receiving, at a transmitter, data for transmission over an unlicensed carrier, means for calculating, at the transmitter, a first available ECCA opportunity of the unlicensed carrier after the means for receiving, wherein the means for calculating uses at least network information and a pseudo-random number, means for performing a CCA check, by the transmitter, on the unlicensed carrier at the first available ECCA opportunity, means, executable in response to detecting a clear CCA check, for transmitting channel reserving signals, by the transmitter, onto the unlicensed carrier, and means, executable in response to failing to detect the clear CCA check, for calculating, by the transmitter, a next available ECCA opportunity of the unlicensed carrier using at least the network information and another pseudo-random number.

In an additional aspect of the disclosure, a computer program product has a computer-readable medium having program code recorded thereon. This program code includes code to receive, at a transmitter, data for transmission over an unlicensed carrier, code to calculate, at the transmitter, a first available ECCA opportunity of the unlicensed carrier after execution of the code to receive, wherein the code to calculate uses at least network information and a pseudo-random number, code to perform a CCA check, by the transmitter, on the unlicensed carrier at the first available ECCA opportunity, code, executable in response to detecting a clear CCA check, to transmit channel reserving signals, by the transmitter, onto the unlicensed carrier, and code, executable in response to failing to detect the clear CCA check, to calculate, by the transmitter, a next available ECCA opportunity of the unlicensed carrier using at least the network information and another pseudo-random number.

In an additional aspect of the disclosure, an apparatus includes at least one processor and a memory coupled to the processor. The processor is configured to receive, at a transmitter, data for transmission over an unlicensed carrier, to calculate, at the transmitter, a first available ECCA opportunity of the unlicensed carrier after the reception of the data for transmission, wherein the configuration of the processor to calculate uses at least network information and a pseudo-random number. The apparatus further includes configuration of the processor to perform a CCA check, by the transmitter, on the unlicensed carrier at the first available ECCA opportunity, to transmit channel reserving signals, by the transmitter, onto the unlicensed carrier in response to detecting a clear CCA check, and to calculate, by the transmitter, a next available ECCA opportunity of the unlicensed carrier using at least the network information and another pseudo-random number in response to failing to detect the clear CCA check.

### BRIEF DESCRIPTION OF THE DRAWINGS

FIG. 1 shows a diagram that illustrates an example of a wireless communications system according to various embodiments.

FIG. 2A shows a diagram that illustrates examples of deployment scenarios for using LTE in an unlicensed spectrum according to various embodiments.

FIG. 2B shows a diagram that illustrates another example of a deployment scenario for using LTE in an unlicensed spectrum according to various embodiments.

FIG. 3 shows a diagram that illustrates an example of carrier aggregation when using LTE concurrently in licensed and unlicensed spectrum according to various embodiments.

FIG. 4 is a block diagram conceptually illustrating a design of a base station/eNB and a UE configured according to one aspect of the present disclosure.

FIG. 5A is a block diagram illustrating a transmission stream in a synchronized, frame based LTE/LTE-A communication system with unlicensed spectrum.

FIG. 5B is a block diagram illustrating a sequence of 28 (0-27) transmission slots for an unlicensed carrier in a synchronized, load based LTE/LTE-A communication system with unlicensed spectrum.

FIG. 6 is a functional block diagram illustrating example blocks executed to implement one aspect of the present disclosure.

FIGS. 7-9 are block diagrams illustrating unlicensed carriers shared by multiple eNBs configured according to one aspect of the present disclosure.

FIG. 10 is a functional block diagram illustrating example blocks executed to implement one aspect of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Operators have so far looked at WiFi as the primary mechanism to use unlicensed spectrum to relieve ever increasing levels of congestion in cellular networks. However, a new carrier type (NCT) based on LTE/LTE-A including an unlicensed spectrum may be compatible with carrier-grade WiFi, making LTE/LTE-A with unlicensed spectrum an alternative to WiFi. LTE/LTE-A with unlicensed spectrum may leverage LTE concepts and may introduce some modifications to physical layer (PHY) and media access control (MAC) aspects of the network or network devices to provide efficient operation in the unlicensed spectrum and to meet regulatory requirements. The unlicensed spectrum may range from 600 Megahertz (MHz) to 6 Gigahertz (GHz), for example. In some scenarios, LTE/LTE-A with unlicensed spectrum may perform significantly better than WiFi. For example, an all LTE/LTE-A with unlicensed spectrum deployment (for single or multiple operators) compared to an all WiFi deployment, or when there are dense small cell deployments, LTE/LTE-A with unlicensed spectrum may perform significantly better than WiFi. LTE/LTE-A with unlicensed spectrum may perform better than WiFi in other scenarios such as when LTE/LTE-A with unlicensed spectrum is mixed with WiFi (for single or multiple operators).

For a single service provider (SP), an LTE/LTE-A network with unlicensed spectrum may be configured to be synchronous with a LTE network on the licensed spectrum. However, LTE/LTE-A networks with unlicensed spectrum deployed on a given channel by multiple SPs may be configured to be synchronous across the multiple SPs. One approach to incorporate both the above features may involve using a constant timing offset between LTE/LTE-A networks without unlicensed spectrum and LTE/LTE-A networks with unlicensed spectrum for a given SP. An LTE/LTE-A network with unlicensed spectrum may provide unicast and/or multicast services according to the needs of the SP. Moreover, an LTE/LTE-A network with unlicensed spectrum may operate in a bootstrapped mode in which LTE cells act as anchor and provide relevant cell information (e.g., radio frame timing, common channel configuration, system frame number or SFN, etc.) for LTE/LTE-A cells with unlicensed spectrum. In this mode, there may be close interworking between LTE/LTE-A without unlicensed spectrum and LTE/LTE-A with unlicensed spectrum. For example, the bootstrapped mode may support the supplemental downlink and the carrier aggregation modes described above. The PHY-MAC layers of the LTE/LTE-A network with unlicensed spectrum may operate in a standalone mode in which the LTE/LTE-A network with unlicensed spectrum operates independently from an LTE network without unlicensed spectrum. In this case, there may be a loose interworking between LTE without unlicensed spectrum and LTE/LTE-A with unlicensed spectrum based on RLC-level aggregation with co-located LTE/LTE-A with/without unlicensed spectrum cells, or multiflow across multiple cells and/or base stations, for example.

The techniques described herein are not limited to LTE, and may also be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

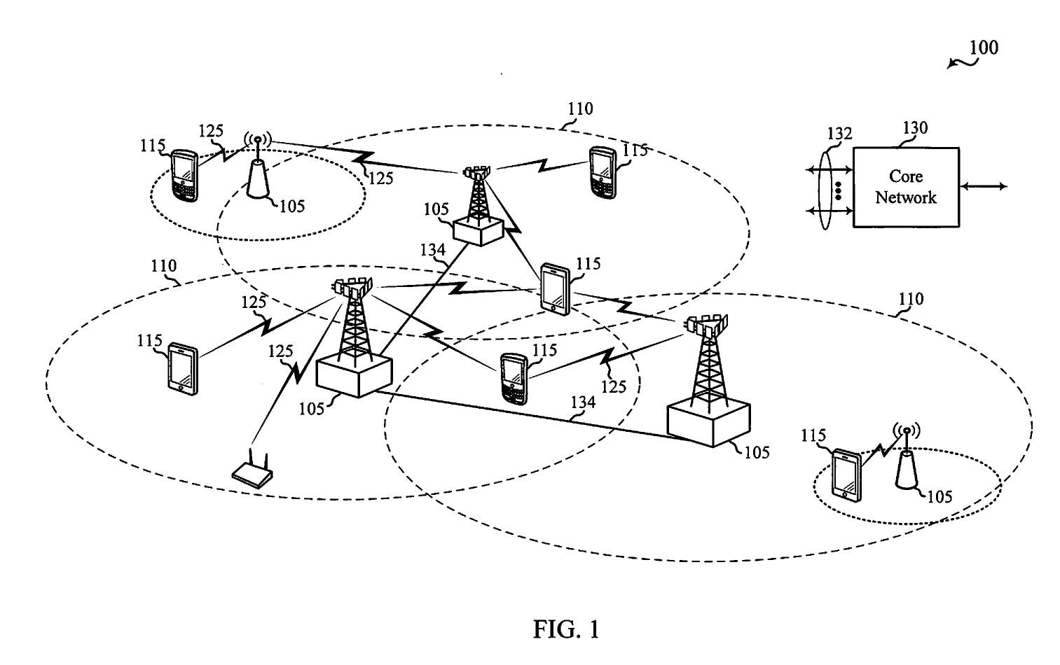

Referring first to FIG. 1, a diagram illustrates an example of a wireless communications system or network 100. The system 100 includes base stations (or cells) 105, communication devices 115, and a core network 130. The base stations 105 may communicate with the communication devices 115 under the control of a base station controller (not shown), which may be part of the core network 130 or the base stations 105 in various embodiments. Base stations 105 may communicate control information and/or user data with the core network 130 through backhaul links 132. In embodiments, the base stations 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the devices 115 via one or more base station antennas. Each of the base station 105 sites may provide communication coverage for a respective geographic area 110. In some embodiments, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 110 for a base station may be divided into sectors making up only a portion of the coverage area (not shown). The system 100 may include base stations 105 of different types (e.g., macro, micro, and/or pico base stations). There may be overlapping coverage areas for different technologies.

In some embodiments, the system 100 is an LTE/LTE-A network that supports one or more unlicensed spectrum modes of operation or deployment scenarios. In other embodiments, the system 100 may support wireless communications using an unlicensed spectrum and an access technology different from LTE/LTE-A with unlicensed spectrum, or a licensed spectrum and an access technology different from LTE/LTE-A. The terms evolved Node B (eNB) and user equipment (UE) may be generally used to describe the base stations 105 and devices 115, respectively. The system 100 may be a Heterogeneous LTE/LTE-A network with or without unlicensed spectrum in which different types of eNBs provide coverage for various geographical regions. For example, each eNB 105 may provide communication coverage for a macro cell, a pico cell, a femto cell, and/or other types of cell. Small cells such as pico cells, femto cells, and/or other types of cells may include low power nodes or LPNs. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The core network 130 may communicate with the eNBs 105 via a backhaul 132 (e.g., S1, etc.). The eNBs 105 may also communicate with one another, e.g., directly or indirectly via backhaul links 134 (e.g., X2, etc.) and/or via backhaul links 132 (e.g., through core network 130). The system 100 may support synchronous or asynchronous operation. For synchronous operation, the eNBs may have similar frame and/or gating timing, and transmissions from different eNBs may be approximately aligned in time. For asynchronous operation, the eNBs may have different frame and/or gating timing, and transmissions from different eNBs may not be aligned in time. The techniques described herein may be used for either synchronous or asynchronous operations.

The UEs 115 are dispersed throughout the system 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The communications links 125 shown in system 100 may include uplink (UL) transmissions from a mobile device 115 to a base station 105, and/or downlink (DL) transmissions, from a base station 105 to a mobile device 115. The downlink transmissions may also be called forward link transmissions while the uplink transmissions may also be called reverse link transmissions. The downlink transmissions may be made using a licensed spectrum (e.g., LTE), an unlicensed spectrum (e.g., LTE/LTE-A with unlicensed spectrum), or both (LTE/LTE-A with/without unlicensed spectrum). Similarly, the uplink transmissions may be made using a licensed spectrum (e.g., LTE), an unlicensed spectrum (e.g., LTE/LTE-A with unlicensed spectrum), or both (LTE/LTE-A with/without unlicensed spectrum).

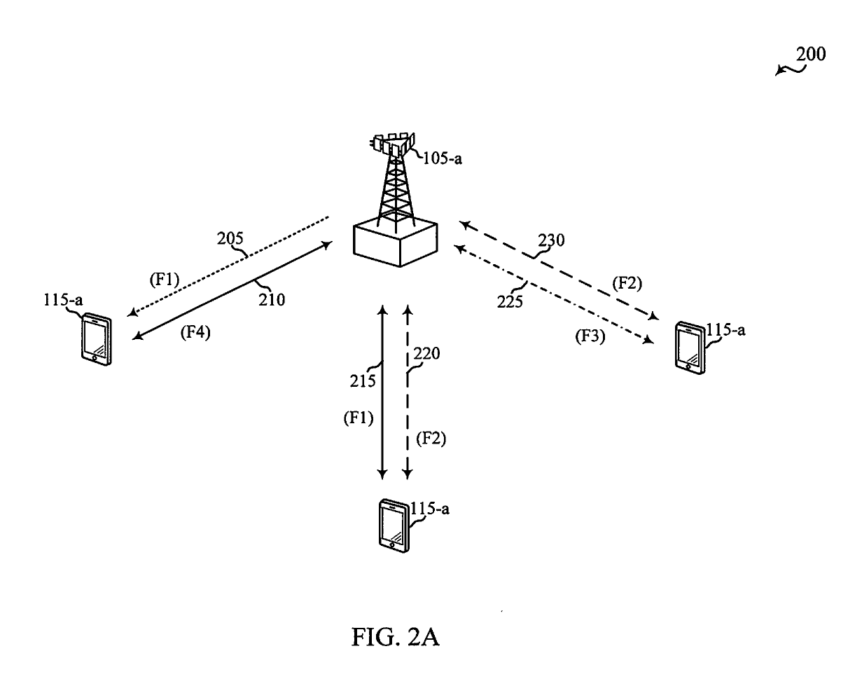

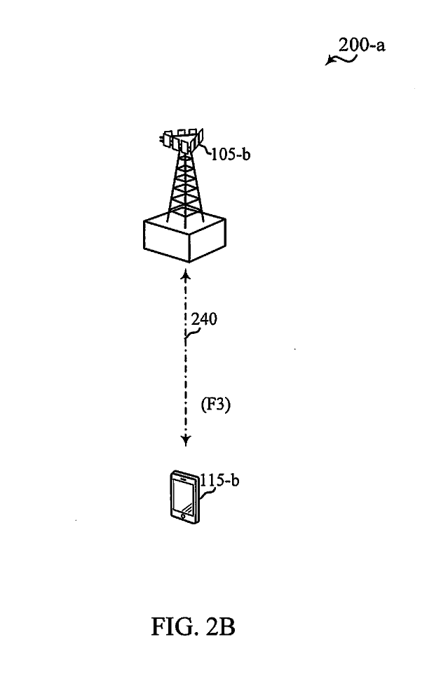

In some embodiments of the system 100, various deployment scenarios for LTE/LTE-A with unlicensed spectrum may be supported including a supplemental downlink (SDL) mode in which LTE downlink capacity in a licensed spectrum may be offloaded to an unlicensed spectrum, a carrier aggregation mode in which both LTE downlink and uplink capacity may be offloaded from a licensed spectrum to an unlicensed spectrum, and a standalone mode in which LTE downlink and uplink communications between a base station (e.g., eNB) and a UE may take place in an unlicensed spectrum. Base stations 105 as well as UEs 115 may support one or more of these or similar modes of operation. OFDMA communications signals may be used in the communications links 125 for LTE downlink transmissions in an unlicensed spectrum, while SC-FDMA communications signals may be used in the communications links 125 for LTE uplink transmissions in an unlicensed spectrum. Additional details regarding the implementation of LTE/LTE-A with unlicensed spectrum deployment scenarios or modes of operation in a system such as the system 100, as well as other features and functions related to the operation of LTE/LTE-A with unlicensed spectrum, are provided below with reference to FIGS. 2A-10.

Turning next to FIG. 2A, a diagram 200 shows examples of a supplemental downlink mode and of a carrier aggregation mode for an LTE network that supports LTE/LTE-A with unlicensed spectrum. The diagram 200 may be an example of portions of the system 100 of FIG. 1. Moreover, the base station 105-a may be an example of the base stations 105 of FIG. 1, while the UEs 115-a may be examples of the UEs 115 of FIG. 1.

In the example of a supplemental downlink mode in diagram 200, the base station 105-a may transmit OFDMA communications signals to a UE 115-a using a downlink 205. The downlink 205 is associated with a frequency F1 in an unlicensed spectrum. The base station 105-a may transmit OFDMA communications signals to the same UE 115-a using a bidirectional link 210 and may receive SC-FDMA communications signals from that UE 115-a using the bidirectional link 210. The bidirectional link 210 is associated with a frequency F4 in a licensed spectrum. The downlink 205 in the unlicensed spectrum and the bidirectional link 210 in the licensed spectrum may operate concurrently. The downlink 205 may provide a downlink capacity offload for the base station 105-a. In some embodiments, the downlink 205 may be used for unicast services (e.g., addressed to one UE) services or for multicast services (e.g., addressed to several UEs). This scenario may occur with any service provider (e.g., traditional mobile network operator or MNO) that uses a licensed spectrum and needs to relieve some of the traffic and/or signaling congestion.

In one example of a carrier aggregation mode in diagram 200, the base station 105-a may transmit OFDMA communications signals to a UE 115-a using a bidirectional link 215 and may receive SC-FDMA communications signals from the same UE 115-a using the bidirectional link 215. The bidirectional link 215 is associated with the frequency F1 in the unlicensed spectrum. The base station 105-a may also transmit OFDMA communications signals to the same UE 115-a using a bidirectional link 220 and may receive SC-FDMA communications signals from the same UE 115-a using the bidirectional link 220. The bidirectional link 220 is associated with a frequency F2 in a licensed spectrum. The bidirectional link 215 may provide a downlink and uplink capacity offload for the base station 105-a. Like the supplemental downlink described above, this scenario may occur with any service provider (e.g., MNO) that uses a licensed spectrum and needs to relieve some of the traffic and/or signaling congestion.

In another example of a carrier aggregation mode in diagram 200, the base station 105-a may transmit OFDMA communications signals to a UE 115-a using a bidirectional link 225 and may receive SC-FDMA communications signals from the same UE 115-a using the bidirectional link 225. The bidirectional link 225 is associated with the frequency F3 in an unlicensed spectrum. The base station 105-a may also transmit OFDMA communications signals to the same UE 115-a using a bidirectional link 230 and may receive SC-FDMA communications signals from the same UE 115-a using the bidirectional link 230. The bidirectional link 230 is associated with the frequency F2 in the licensed spectrum. The bidirectional link 225 may provide a downlink and uplink capacity offload for the base station 105-a. This example and those provided above are presented for illustrative purposes and there may be other similar modes of operation or deployment scenarios that combine LTE/LTE-A with or without unlicensed spectrum for capacity offload.

As described above, the typical service provider that may benefit from the capacity offload offered by using LTE/LTE-A with unlicensed spectrum is a traditional MNO with LTE spectrum. For these service providers, an operational configuration may include a bootstrapped mode (e.g., supplemental downlink, carrier aggregation) that uses the LTE primary component carrier (PCC) on the licensed spectrum and the LTE secondary component carrier (SCC) on the unlicensed spectrum.

In the supplemental downlink mode, control for LTE/LTE-A with unlicensed spectrum may be transported over the LTE uplink (e.g., uplink portion of the bidirectional link 210). One of the reasons to provide downlink capacity offload is because data demand is largely driven by downlink consumption. Moreover, in this mode, there may not be a regulatory impact since the UE is not transmitting in the unlicensed spectrum. There is no need to implement listen-before-talk (LBT) or carrier sense multiple access (CSMA) requirements on the UE. However, LBT may be implemented on the base station (e.g., eNB) by, for example, using a periodic (e.g., every 10 milliseconds) clear channel assessment (CCA) and/or a grab-and-relinquish mechanism aligned to a radio frame boundary.

In the carrier aggregation mode, data and control may be communicated in LTE (e.g., bidirectional links 210, 220, and 230) while data may be communicated in LTE/LTE-A with unlicensed spectrum (e.g., bidirectional links 215 and 225). The carrier aggregation mechanisms supported when using LTE/LTE-A with unlicensed spectrum may fall under a hybrid frequency division duplexing-time division duplexing (FDD-TDD) carrier aggregation or a TDD-TDD carrier aggregation with different symmetry across component carriers.

FIG. 2B shows a diagram 200-a that illustrates an example of a standalone mode for LTE/LTE-A with unlicensed spectrum. The diagram 200-a may be an example of portions of the system 100 of FIG. 1. Moreover, the base station 105-b may be an example of the base stations 105 of FIG. 1 and the base station 105-a of FIG. 2A, while the UE 115-b may be an example of the UEs 115 of FIG. 1 and the UEs 115-a of FIG. 2A.

In the example of a standalone mode in diagram 200-a, the base station 105-b may transmit OFDMA communications signals to the UE 115-b using a bidirectional link 240 and may receive SC-FDMA communications signals from the UE 115-b using the bidirectional link 240. The bidirectional link 240 is associated with the frequency F3 in an unlicensed spectrum described above with reference to FIG. 2A. The standalone mode may be used in non-traditional wireless access scenarios, such as in-stadium access (e.g., unicast, multicast). The typical service provider for this mode of operation may be a stadium owner, cable company, event hosts, hotels, enterprises, and large corporations that do not have licensed spectrum. For these service providers, an operational configuration for the standalone mode may use the PCC on the unlicensed spectrum. Moreover, LBT may be implemented on both the base station and the UE.

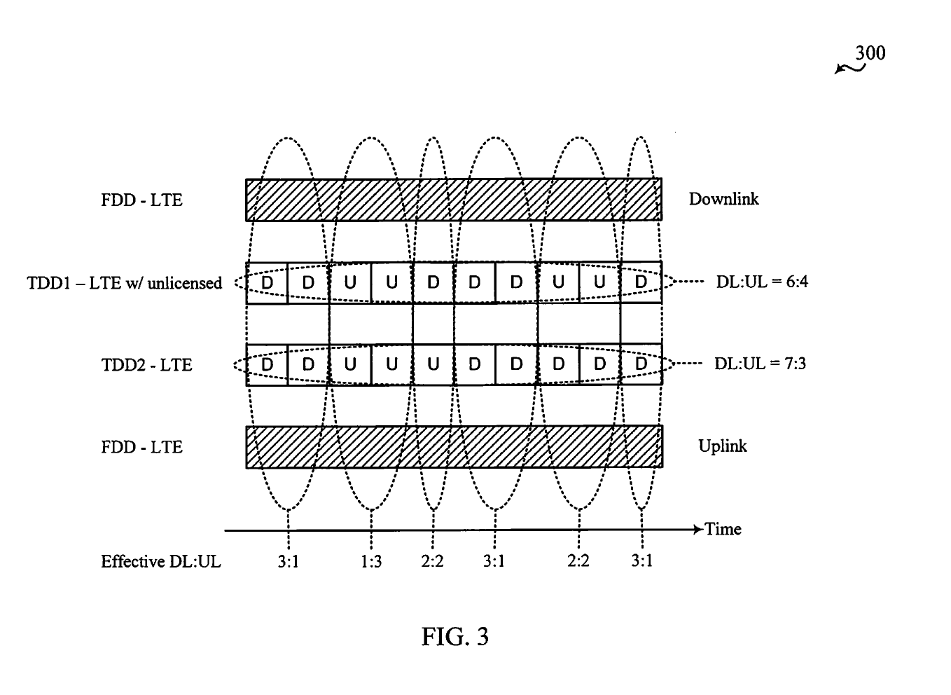

Turning next to FIG. 3, a diagram 300 illustrates an example of carrier aggregation when using LTE concurrently in licensed and unlicensed spectrum according to various embodiments. The carrier aggregation scheme in diagram 300 may correspond to the hybrid FDD-TDD carrier aggregation described above with reference to FIG. 2A. This type of carrier aggregation may be used in at least portions of the system 100 of FIG. 1. Moreover, this type of carrier aggregation may be used in the base stations 105 and 105-a of FIG. 1 and FIG. 2A, respectively, and/or in the UEs 115 and 115-a of FIG. 1 and FIG. 2A, respectively.

In this example, an FDD (FDD-LTE) may be performed in connection with LTE in the downlink, a first TDD (TDD1) may be performed in connection with LTE/LTE-A with unlicensed spectrum, a second TDD (TDD2) may be performed in connection with LTE with licensed spectrum, and another FDD (FDD-LTE) may be performed in connection with LTE in the uplink with licensed spectrum. TDD1 results in a DL:UL ratio of 6:4, while the ratio for TDD2 is 7:3. On the time scale, the different effective DL:UL ratios are 3:1, 1:3, 2:2, 3:1, 2:2, and 3:1. This example is presented for illustrative purposes and there may be other carrier aggregation schemes that combine the operations of LTE/LTE-A with or without unlicensed spectrum.

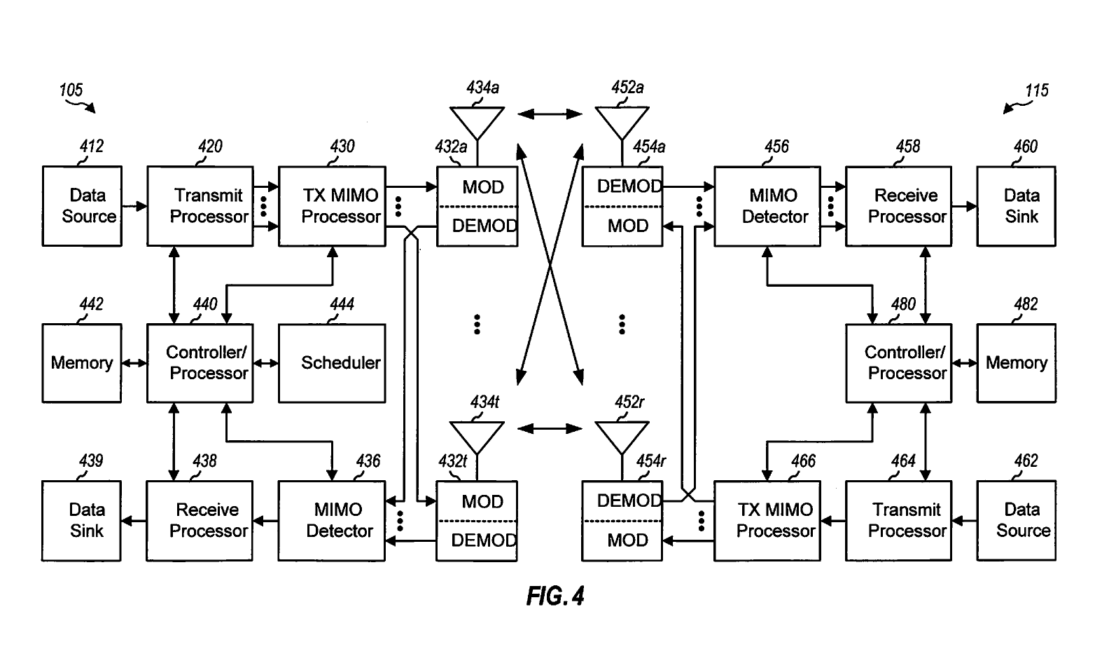

FIG. 4 shows a block diagram of a design of a base station/eNB 105 and a UE 115, which may be one of the base stations/eNBs and one of the UEs in FIG. 1. The eNB 105 may be equipped with antennas 434a through 434t, and the UE 115 may be equipped with antennas 452a through 452r. At the eNB 105, a transmit processor 420 may receive data from a data source 412 and control information from a controller/processor 440. The control information may be for the physical broadcast channel (PBCH), physical control format indicator channel (PCFICH), physical hybrid automatic repeat request indicator channel (PHICH), physical downlink control channel (PDCCH), etc. The data may be for the physical downlink shared channel (PDSCH), etc. The transmit processor 420 may process (e.g., encode and symbol map) the data and control information to obtain data symbols and control symbols, respectively. The transmit processor 420 may also generate reference symbols, e.g., for the primary synchronization signal (PSS), secondary synchronization signal (SSS), and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODS) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 115, the antennas 452a through 452r may receive the downlink signals from the eNB 105 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 115 to a data sink 460, and provide decoded control information to a controller/processor 480.

On the uplink, at the UE 115, a transmit processor 464 may receive and process data (e.g., for the physical uplink shared channel (PUSCH)) from a data source 462 and control information (e.g., for the physical uplink control channel (PUCCH)) from the controller/processor 480. The transmit processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the eNB 105. At the eNB 105, the uplink signals from the UE 115 may be received by the antennas 434, processed by the modulators 432, detected by a MIMO detector 436 if applicable, and further processed by a receive processor 438 to obtain decoded data and control information sent by the UE 115. The processor 438 may provide the decoded data to a data sink 439 and the decoded control information to the controller/processor 440.

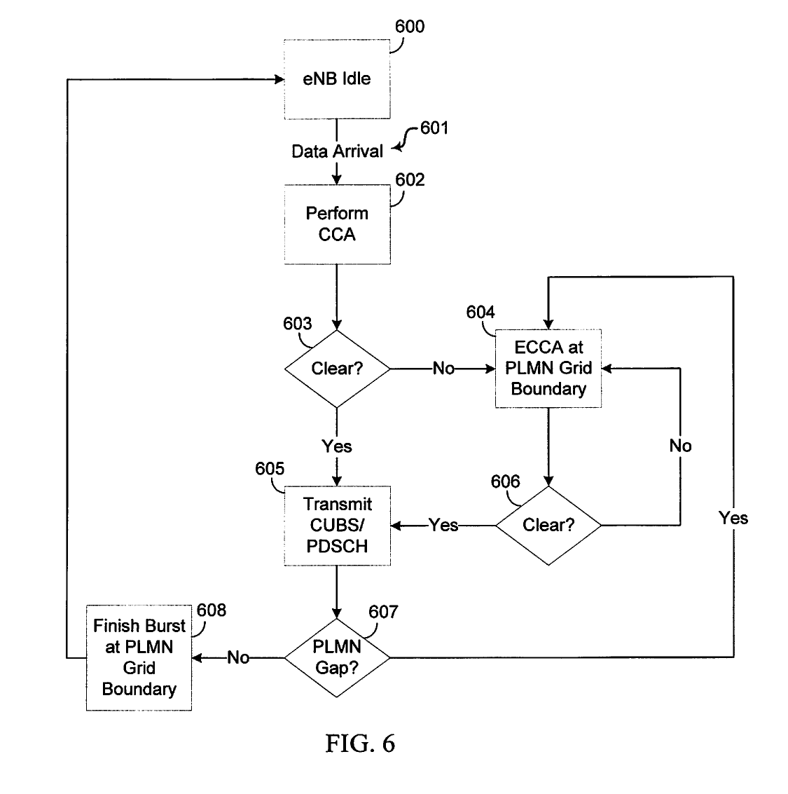

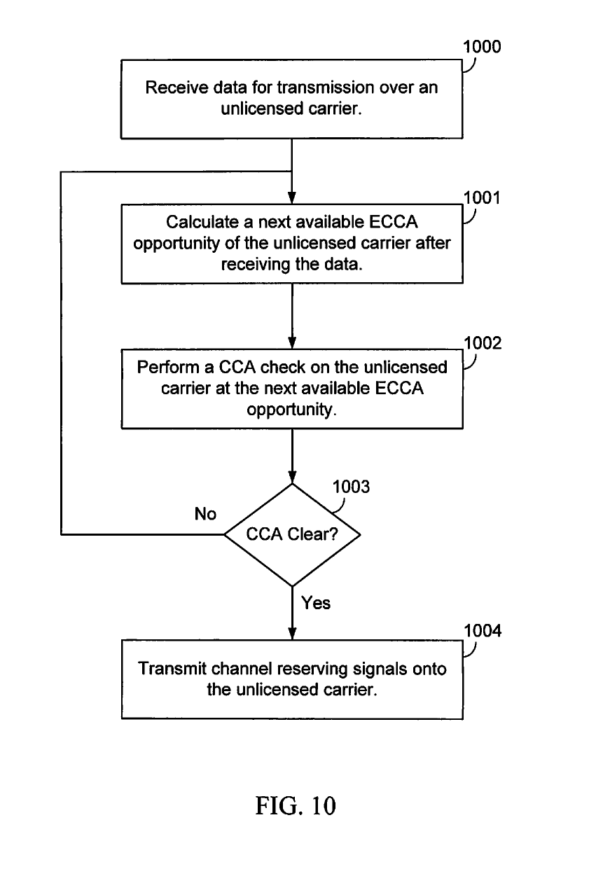

The controllers/processors 440 and 480 may direct the operation at the eNB 105 and the UE 115, respectively. The controller/processor 440 and/or other processors and modules at the eNB 105 may perform or direct the execution of various processes for the techniques described herein. The controllers/processor 480 and/or other processors and modules at the UE 115 may also perform or direct the execution of the functional blocks illustrated in FIGS. 6 and 10, and/or other processes for the techniques described herein. The memories 442 and 482 may store data and program codes for the eNB 105 and the UE 115, respectively. A scheduler 444 may schedule UEs for data transmission on the downlink and/or uplink.

Initially contemplated configurations of LTE/LTE-A networks using unlicensed spectrum provide for access of the unlicensed spectrum using a frame-based structure. Frame-based designs for LTE/LTE-A with unlicensed spectrum offer many advantages, including common design elements shared with standard LTE systems that use only licensed spectrum. However, frame-based LTE/LTE-A with unlicensed spectrum may have some fundamental issues when co-existing with a load-based system. Frame-based systems perform CCA checks at a fixed time during the frame, where the fixed time is usually a small fraction of the frame (typically around 5%). For example, in a frame-based system, CCA checks may occur in the special subframes in one of seven symbols after the guard period of the special subframe. When a load-based system occupies a channel, transmission gaps occurring between transmission bursts of the load-based system are unlikely to fall into the CCA period of a frame-based system. Load-based systems generally capture the channel until buffer is exhausted.

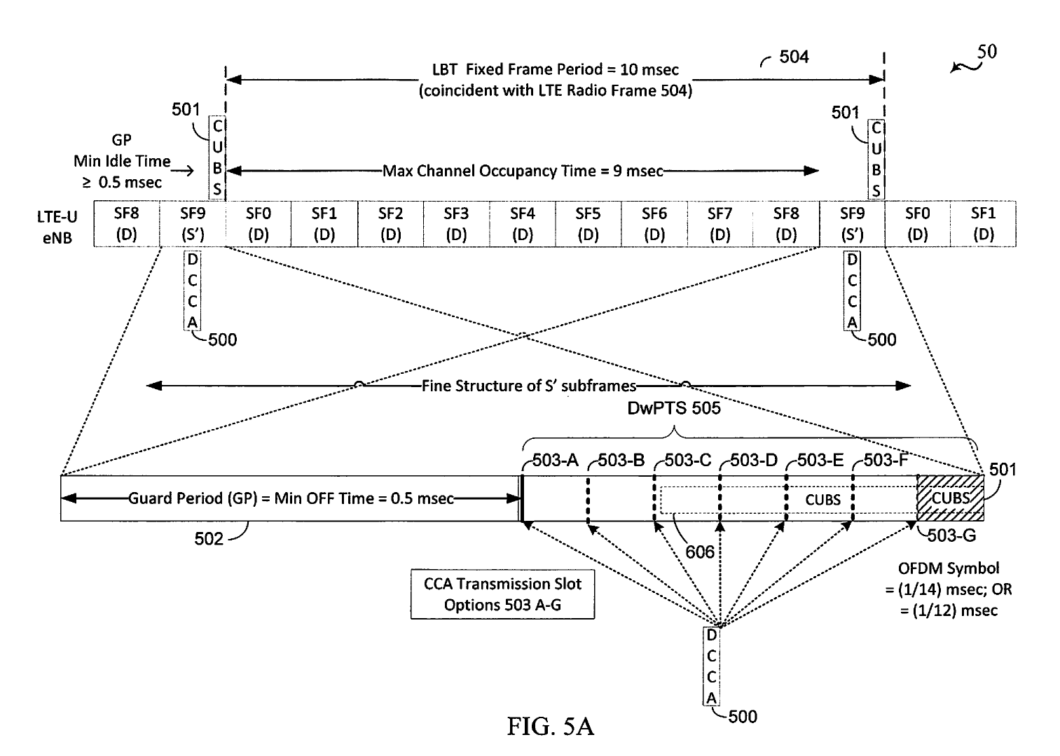

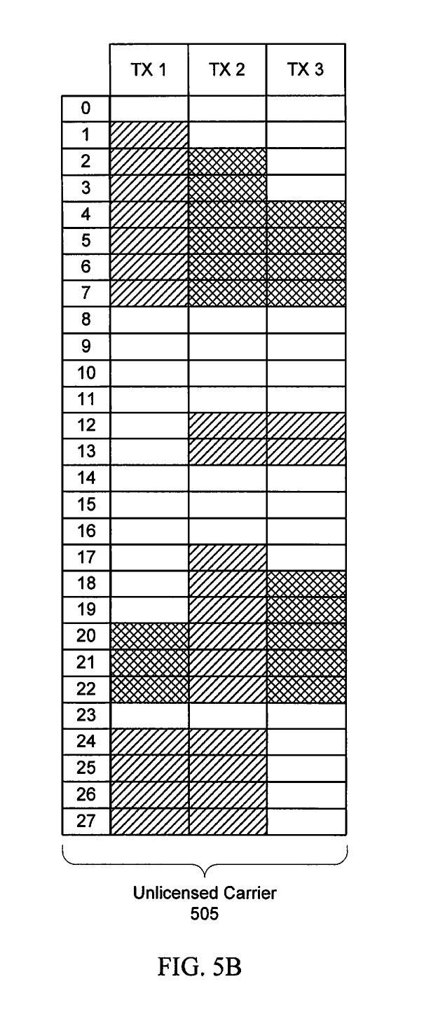

FIG. 5A is a block diagram illustrating transmission stream 50 in a synchronized, frame based LTE/LTE-A communication system with unlicensed spectrum. Transmission stream 50 is divided into LTE radio frames, such as LTE radio frame 504, each of such radio frame further divided into 10 subframes (subframes 0-9) that may be configured for uplink communication (U), downlink communications (D), or a special subframe (S′) which includes a uplink pilot time slot (UpPTS) (not shown) that may include uplink communications, a guard period, such as guard period 502, and a downlink pilot time slot (DwPTS) 505 that may include downlink communications. Prior to initiating communications on an unlicensed carrier, the transmitter originating transmission stream 50 transmits downlink CCA (DCCA) 500 in one of the fixed seven possible transmission slots, CCA opportunities 503-A-503-G. If the transmitter detects a clear CCA, then the unlicensed channel is occupied by channel usage beacon signal (CUBS) 501 prior to any actual data transmissions from the transmitter. Once a CCA has been conducted, the transmitter will not be required to perform another CCA check for a fixed period of 10 ms, which is incident to the radio frame length, such as LTE radio frame 504.

The main function of CUBS in communication systems employing LBT procedures is to reserve the channel. A CUBS is generally a wideband signal with frequency reuse that carries at least the transmitter and/or receiver identify (e.g., cell identifier (ID) or PLMN for a base station and a cell radio network temporary identifier (C-RNTI) for a UE or mobile device). The transmit power for CUBS may also be linked to a CCA threshold. Additionally, CUBS may be used to help setting automatic gain control (AGC) at the receiver. From these perspectives, any signal spanning 80% of channel bandwidth could be sufficient. A third function of the CUBS provides notice to the receiver that the CCA check succeeded. With this information, a receiver can expect data transmissions from the transmitter.

When competing deployments are in the vicinity of the transmitter originating transmission stream 50, the transmitter will be assigned one of CCA opportunities 503-A-503-G, while the competing deployments may be assigned others of the CCA opportunities 503-A-503-G. It is likely that the deployment assigned for CCA in an earlier one of CCA opportunities 503-A-503-G may detect a clear CCA and begin CUBS transmission before the competing deployment attempts CCA. The subsequent CCA attempt will then fail through detection of the CUBS transmission. For example, in an alternate aspect illustrated in FIG. 5A, the transmitter is assigned CCA opportunity 503-C for the CCA check. The transmitter detects a clear CCA and immediately begins transmitting CUBS 506. Any competing deployments assigned to any of CCA opportunities 503-D-503-G will detect CUBS 506 and their respective CCA checks will fail.

Various aspects of the present disclosure would provide for LTE/LTE-A networks with unlicensed spectrum designed as a load-based system. A load-based design may then take advantage of the random gaps created by another load-based system in order to more-efficiently engage in data transmissions over the unlicensed spectrum. One of the actions taken to implement such a load-based LTE/LTE-A network with unlicensed spectrum is to synchronize the nodes in a particular public land mobile number (PLMN) when each of these nodes contends for a vacant channel at random times. Synchronization of nodes within the same PLMN is also an advantage when competing with other unlicensed spectrum technologies, such as WiFi, 802.11, 802.15, and the like. However, these other unlicensed spectrum technologies tend to decrease in reuse factor when node density increases.

It should be noted that, in implementing a load-based LTE/LTE-A network with unlicensed spectrum, a challenge is fitting a finer timing granularity into the existing LTE numerology. For example, LTE has a 71.4 μs OFDM symbol numerology. This OFDM symbol numerology would need to be adapted into a more constricted CCA window.

FIG. 5B is a block diagram illustrating a sequence of 28 (0-27) transmission slots for an unlicensed carrier 505 in a synchronized, load based LTE/LTE-A communication system with unlicensed spectrum. Unlicensed carrier 505 is shared by three transmitters, TXs 1-3. The transmitters, TXs 1-3, may be transmitters located within a base station or eNB, or may be located within a mobile device or UE. In a load based LBT transmission system, transmitters attempt to capture the channel and transmit buffer data when the data is stored into the buffer, instead of waiting for the fixed CCA opportunity in a frame based system. In one example of operation illustrated in FIG. 5B, at slot 1, TX 1 receives data in its buffer and performs an LBT procedure to capture unlicensed carrier 505. After the successful LBT procedure, TX 1 begins its transmission burst at slot 1 and continues transmission until slot 7. At slot 2, TX 2 receives data in its buffer and attempts to capture unlicensed carrier 505. However, because eNB 1 is already transmitting on unlicensed carrier 505, TX 2 is blocked from transmissions until the channel is again clear. Similarly, at slot 4, TX 3 is ready to begin transmissions and attempts to capture unlicensed carrier 505, but is blocked from transmissions until the channel is again clear.

At slot 12, both TXs 2 and 3 attempt to capture unlicensed carrier 505 for transmission of buffer data. Because unlicensed carrier 505 is clear at slot 12, both of TXs 2 and 3 begin data transmission at slot 12 through slot 13.

At slot 17, TX 2 is ready to transmit buffer data again and attempts to capture unlicensed carrier 505. With no other transmissions detected, TX 2 begins transmitting data at slot 17 until slot 22. At slot 18, TX 3 receives buffer data and is ready to transmit. TX 3 attempts to capture unlicensed carrier 505, but, because of the transmissions from TX 2, the LBT fails, thus, blocking TX 3 from transmission until the channel is again clear. Similarly, TX 1 is ready to begin transmission at slot 20. However, TX 1 will also be blocked from transmitting on unlicensed carrier 505 until the channel is again clear.

Once unlicensed carrier 505 is again clear at slot 23, TX 1 is ready to re-attempt capture of unlicensed carrier 505. TX 2 also receives data and is ready to transmit again at slot 24. TX 2 also attempts to capture unlicensed carrier 505 for transmission. Because there are no other transmission occurring on unlicensed carrier 505 detected by either TX 1 or TX 2, both TXs 1 and 2 begin transmission at slot 24 and continue through slot 27. As illustrated, each of TXs 1-3 attempt transmission according to their loading.

Existing load based equipment may operate according to alternative LBT procedures. In one example of such operation, a CCA check is performed having a duration of greater than or equal to 20 μs (T_cca>=20 μs, where T_cca is the duration). If the CCA check is clear, then the transmitter may transmit up to 13/32×q ms. When the CCA check fails, the transmitter performs an extended CCA using a counter for idle CCA slots (C_ecca=N; N˜U(1,q), where C_ecca is the counter and q is fixed from 4 to 32). Each time the transmitter detects a clear channel, the counter C_ecca decrements by 1, such that when the counter C_ecca reaches 0, the transmitter transmits its payload. When considering competition for multiple unlicensed spectrum carriers between multiple transmitters, the current LBT procedure makes it difficult to synchronize the transmission time.

In one alternative load based LBT procedure configured according to aspects of the present disclosure, a transmitter would perform a CCA check have a duration T_cca>=20 μs. If the CCA check is detected to be clear, the transmitter transmits up to 13/32×q ms. In this alternative aspect of the present disclosure, if the CCA check is not clear, the transmitter performs an extended CCA check based on a timer, instead of the counter. The timer is bounded using an extended CCA time of T_ecca=N*T_cca; N˜U(1,q), where T_ecca is the duration of the timer and q is also fixed here from 4 to 32. If the unlicensed carrier is determined to be idle for the duration of the timer, T_ecca, the transmitter transmits its payload.

One design implication from load based LBT procedures is the overhead required for the extended CCA. For a large buffer of transmission data, the extended CCA overhead may be determined by CCA slot time. In the case of an isolated link, the maximum overhead (Max OH) for extended CCA is determined according to:

$$\begin{matrix}Max OH = T\_ecca / MaxDuration \\ = CCASlotTime * Q / ( 13 / 32 * Q ) \\ = CCASlotTime / ( 13 / 32 )\end{matrix} \qquad ( 1 )$$

Where the average overhead, Average OH, may be considered to be half of the maximum overhead (Max OH).

In selecting an effective CCA slot time, consideration is made between the slot time and resulting percentage of slot time used for overhead. For example, the minimum candidate CCA slot time would be 20 μs in order to comply with the minimum CCA duration for alternative load based LBT procedures. With the minimum 20 μs, the resulting overhead makes up 4.9% of the slot time. At a CCA slot time of ½ of an OFDM symbol (35.7 μs), the resulting overhead percentage is 8.8% of the slot time. As the candidate slot times increase, the percentage of the slot time attributed to overhead also increases. At 50 μs the resulting overhead is 12.3% of the slot time and, at a full OFDM symbol time (71.4 μs), the resulting overhead reaches 17.6% of the slot time, which is likely too much overhead to be a feasible alternative. For aspects of the present disclosure, a baseline CCA slot time of ½ OFDM symbol is selected, which also allows for possible alignment with current LTE numerology at even CCA Slot boundaries.

In further considerations of the design of alternative load based LBT procedures, the maximum CCA duration is a function of the contention parameter, Q. Aspects of the present disclosure may align selection of the contention parameter, Q, or maximum CCA duration with the system-defined maximum burst duration. The maximum burst duration may typically coincide with the frame length defined in the system. For example, standard LTE systems define a frame length of 10 ms, while LTE half-frame (HF) defines the frame length of 5 ms, and in LTE deployments in Japan, the frame length is defined as only 4 ms. Thus, the maximum duration and contention parameter may align with the particular system types, e.g., LTE HF, LTE RF, or Japan Max Burst. The relationship between LTE, LTE HF, and Japan Max Burst is illustrated in Table 1 below.

Additional design implications of alternative load based LBT procedures consider the contention window as a function of both the CCA slot time and Q. As such, consideration may be given to making the load based LTE/LTE-A networks with unlicensed spectrum comparable to the contention window in typical IEEE 802.11ac operations. The minimum contention window in standard IEEE 802.11ac operations is 135 μs, followed by exponential growth as the contention parameter, Q, increases. The relationship between the contention window and Q value is illustrated in Table 2 below.

It should be noted that a contention parameter of 12 (Q=12) may provide beneficial results for the contention window and for load based equipment LBT procedures.

Aspects of the present disclosure provide for configuration of load based equipment to operate in LTE/LTE-A networks having unlicensed spectrum, in which the load based equipment is configured using parameters that result in operation that aligns with standard LTE operations. For example, in one aspect of the present disclosure, a load based transmitter would operate with a CCA slot time of 35.7 μs, and a contention parameter, Q, of 12, which results in an extended CCA contention window of Q×SlotTime=429 μs. Because the CCA slot time is one-half of an LTE OFDM symbol duration, CCA slots and CUBS timing may be aligned without significant change to standard LTE operations. In one example aspect, the maximum burst duration may be set to 4.9 ms, which aligns the max burst duration with LTE HF. The expected gap due to the max burst duration would be less than 2%. CCA and CUBS overhead, without contention, would result in: 35.7 μs+35.7 μs/5 ms<1.5%. The extended CCA overhead, with contention, would result in a maximum overhead for a large payload of less than 9%. Therefore, the average overhead for large payload would equal approximately 4.4%. Operations under these parameters of load based transmitters operating in LTE/LTE-A networks with unlicensed spectrum would be comparable to a third attempt in an 802.11 ac WiFi attempt, considering 802.11 ac/WiFi contention window size=9 μs×15=135 μs.

In an additional aspect of the present disclosure that uses more aggressive, alternative operational parameters, a load based transmitter may operate with a CCA slot time of 35.7 μs, and a contention parameter, Q, of 5, which results in an extended CCA contention window of Q×SlotTime=179 μs. With a maximum burst duration set to 2.03 ms, the transmitter may be able to align with two LTE subframes, in which the CCA and CUBS overhead, without contention, results in: 35.7 μs+35.7 μs/2 ms<3.5%, which is close to the 802.11 ac/WiFi minimum contention window.

An asynchronous design may be possible by sending a discovery signal in CCA exempt transmissions (CET) without CCA. CET are scheduled to occur every 80 ms in LTE/LTE-A networks with unlicensed spectrum. The asynchronous design would, therefore, simply follow existing procedures for unicast traffic. For example, each transmitter eNB or transmitter UE would attempt to access the channel with a random timer. There would be no simultaneous transmissions from transmitters in the same PLMN and fixed PSS/SSS/PBCH/SIB locations would not be possible. Under such operating conditions, the reuse factor is similar to WiFi, which would not necessarily provide much advantage compared to WiFi.

In one aspect of the present disclosure, a supplemental download (SDL) mode synchronized load based equipment LBT operation is defined. The example aspect includes a synchronous CCA slot with a one-half OFDM symbol resolution (35.7 μs). The CCA slot time would include the CCATime+TransientTime=20 μs+15.7 μs=35.7 μs. If the CCA slot is located in the first half of an OFDM symbol, the eNB would transmit CUBS to occupy one-half of the OFDM symbol. Otherwise, the eNB would transmit two back-to-back CUBS to occupy a full OFDM symbol. PDCCH transmission follows CUBS. Because there is a lack of subframe-level synchronization, there would be no primary cell cross-carrier scheduling from a licensed carrier. In selected example aspects, it may be possible to have a PDCCH over one-half of an OFDM symbol for a single grant. PDSCH transmission follows PDCCH with regular LTE OFDM symbol duration. Therefore, padding may be added if a burst ends at the ½ OFDM symbol location.

In an additional aspect of the present disclosure, an SDL mode synchronized load based equipment LBT operation is defined. In such additional aspect, each PLMN CCA is synchronized, based on the PLMN ID and the System Time. The extended CCA duration would map to the same ending CCA slots. In such additional aspect, a transmitting device would attempt to perform a CCA check at the first CCA opportunity once out of idle mode. If a CCA or extended CCA check is successful, then, in a first step, the transmitter reserves the channel using a channel reservation signal, such as CUBS, before transmitting the burst. The transmitter may finish the burst at a variable burst boundary. If the CCA check or extended CCA check is not clear, then the transmitter will wait until the next common CCA timing. All nodes in the same PLMN may attempt at the same time. If unsuccessful, the transmitter will again wait until the next common CCA timing. Otherwise, the transmitter will reserve the channel, as noted above.

In an additional aspect of the present disclosure, an SDL mode synchronized load based equipment LBT operation is defined having a PLMN grid and a PLMN gap. A PLMN grid defines the extended CCA boundaries over a sequence of symbol durations with pseudo-random duration between [1, q] between each CCA boundary. The PLMN grid aligns all loaded transmitters that are sensing the medium. A PLMN gap is a predetermined “gap” of a symbol or symbols at which each PLMN will end transmission bursts. PLMN gaps in a busy transmission allows for all other transmitting nodes to also access the channel at the next PLMN grid, increasing the reuse level to a reuse of 1, which is much more favorable than reuse in regular 802.11ac/WiFi deployments. A PLMN gap may be defined once every 2/5/10 ms based on q=5, 12, 24. This enables PSS/SSS/PBCH/SIB transmission.

It should be noted that the PLMN gap is similar to the frame boundary of defined in frame based equipment. Frame based equipment defines CCA opportunities at fixed locations, while load based equipment defines the extended CCA opportunities with random durations for carrier sensing and backoff.

FIG. 6 is a functional block diagram illustrating example blocks executed to implement one aspect of the present disclosure. At block 600, a transmitting device, such as an eNB or UE, is in an idle state without data for transmission. At 601, data arrives at the transmitter for transmission to one or more designated receivers. In response to receiving the data, at 601, the transmitter performs a CCA check at block 602.

At block 603, a determination is made whether the transmitter detects a clear channel in response to the CCA check. If interference or additional transmissions on the channel are detected, then, at block 604, the transmitter performs an extended CCA (ECCA) check at the PLMN grid boundary. After delaying the next access attempt to the PLMN grid boundary, at block 606, another determination is made whether the transmitter detects that the channel is now clear, in response to the ECCA check. If the ECCA check also is not detected as clear, then the transmitter will perform another ECCA check at the next PLMN grid boundary, at block 604.

If the transmitter detects a clear channel either during the determination of the CCA check at block 603 or the determination of the ECCA check at block 606, then the transmitter will capture or reserve the channel, at block 605, by transmitting CUBS followed by the data, such as in a PDSCH, or if the data is immediately ready to transmit, as soon as the transmitter would detect the clear channel, it may immediately begin transmitting the data on the channel.

At block 607, a determination is made by the transmitter whether it has reached the PLMN gap. All transmissions for any transmitting transmitters within the same PLMN are scheduled to stop at a designated PLMN gap. Thus, if the PLMN gap is detected through the determination at block 607, then the transmitter ceases transmission of the data burst and performs an ECCA at the next PLMN grid boundary, at block 604. Otherwise, if the PLMN gap is not detected, then, at block 608, the transmitter finishes transmitting the data burst at the PLMN grid boundary associated with the completion of the data transmission. For example, the transmitter may continue to transmit the data burst after successive PLMN grid boundaries until all of the data has been transmitted. The transmitter may add padding to its transmission when the data has all been transmitted prior to the next PLMN grid boundary.

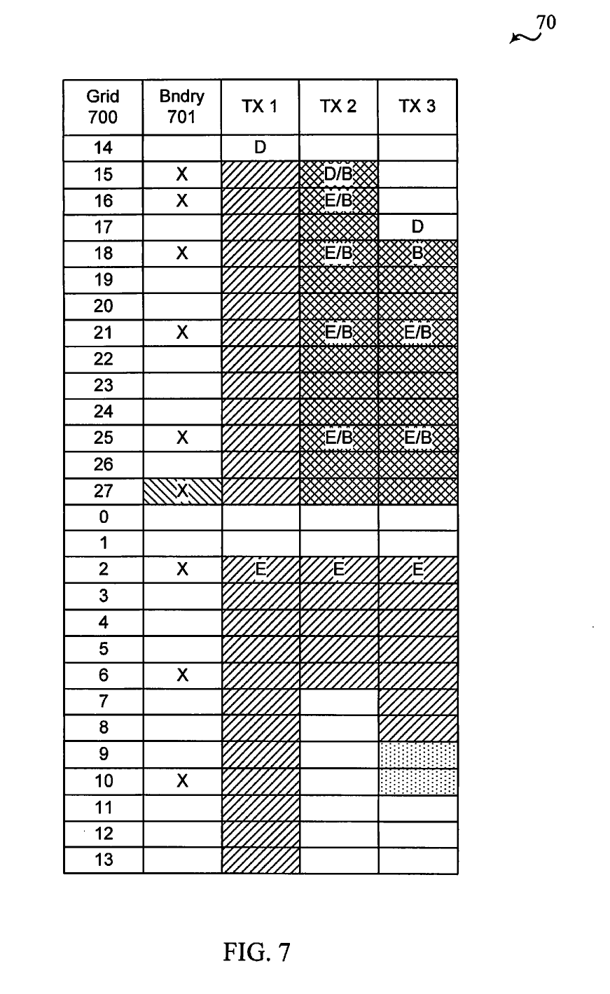

FIG. 7 is a block diagram illustrating an unlicensed carrier 70 shared by multiple eNBs configured according to one aspect of the present disclosure. Unlicensed carrier 70 is shown over multiple slots making up the PLMN grid 700. PLMN boundary 701 provides an indication of which slot of PLMN grid 700 has been designated as a PLMN boundary based on the pseudo-random slot delay assigned. In one example operation, TX 1 is loaded for a long data burst, while eNBs 2 and 3 each are later loaded with shorter data bursts. At slot 14, TX 1 receives the data, D, for transmission and captures unlicensed carrier 70 to begin the long data burst.

At slot 15, TX 2 receives its data and attempts to capture unlicensed carrier 70 by performing a CCA check. However, because TX 1 is already transmitting on unlicensed carrier 70, the CCA check for TX 2 fails and transmission is blocked. At slot 17, TX 3 receives data and attempts to capture unlicensed carrier 70 by performing a CCA check. Again, the ongoing transmissions of the long data burst from TX 1 blocks transmission from eNB 3 through a failed CCA attempt.

Both of TXs 2 and 3, when detecting the original CCA failure, perform extended CCA (ECCA) checks at each next PLMN grid boundary. Thus, TX 2 performs ECCA checks at PLMN boundaries designated for slots 16, 18, 21, and 25, while TX 3 performs ECCA checks at the PLMN boundaries designated for slots 21 and 25. Each time TXs 2 and 3 perform the ECCA checks, because TX 1 continues transmitting the long data burst, the ECCA checks fail, thus, blocking TXs 2 and 3 from transmission.

At slot 27, a PLMN gap has been scheduled. All transmission from each transmitting node within the same PLMN is scheduled to cease at the PLMN gap. Thus, at slot 27, TX 1 ceases transmission of the long data burst. At the next PLMN boundary, at slot 2 of the next grid frame, because each of TXs 1-3 are loaded with data for transmission, each of TXs 1-3 performs a CCA check of unlicensed carrier 70. The CCA checks for each of TXs 1-3 are detected as clear and each of TXs 1-3 begin transmission of their respective data bursts.

Transmissions from each of TXs 1-3 will continue until all of the data has been transmitted and ending transmissions either at a PLMN boundary or at a PLMN gap. For example, TX 2 transmits all of its data through a data burst from slot 3 until the next PLMN boundary at slot 6. At slot 6, TX 2 finishes transmission of its last data in the burst. However, in some circumstances, the data may all be transmitted prior to the next PLMN boundary slot. For example, TX 3 finishes transmitting all of its data at slot 8, prior to the PLMN boundary scheduled for slot 10. TX 3 adds padding or transmits another signal, such as a CUBS over slots 9 and 10, in order to maintain transmission all the way through the next PLMN boundary at slot 10.

According to the example aspects illustrated in FIG. 7, even though TX 1 is loaded for a long burst of traffic, TXs 2 and 3 are not starved from access to unlicensed carrier 70. After the PLMN gap, at slot 27, all transmitting nodes within the PLMN start with a reuse level of 1, which allows each of TXs 1-3 access to unlicensed carrier 70.

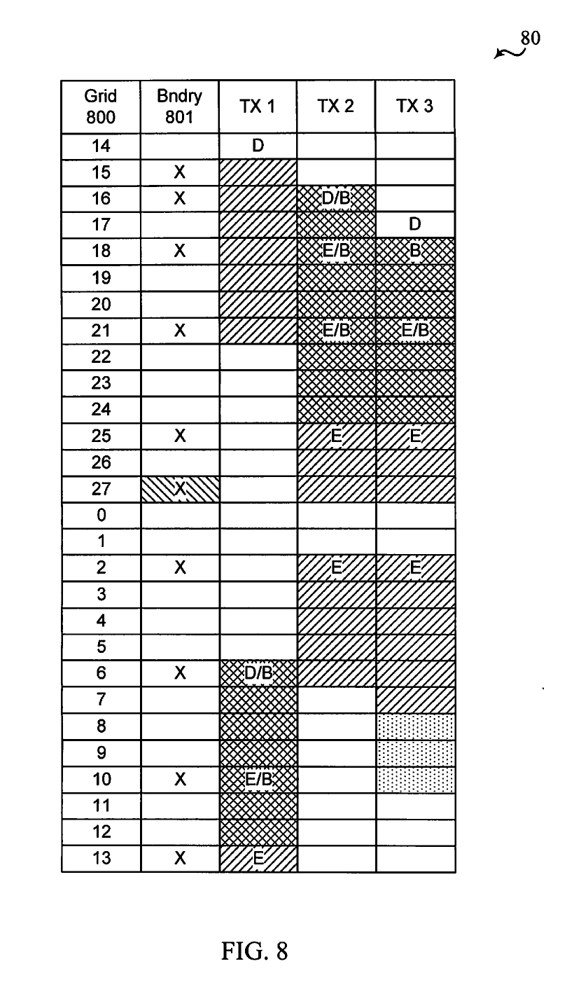

FIG. 8 is a block diagram illustrating an unlicensed carrier 80 shared by multiple transmitting nodes configured according to one aspect of the present disclosure. PLMN grid 800 identifies the sequence of slots for transmission over unlicensed carrier 80 by TXs 1-3. PLMN boundary 801 identifies each of the PLMN boundaries and the PLMN gap scheduled for transmissions according to the various aspects. At slot 14, TX 1 receives data for a short data burst. At the next PLMN boundary, at slot 15, TX 1 performs a CCA check and captures unlicensed carrier 80 by transmitting CUBS and then the data, such as through transmission of PDSCH.

At slot 16, TX 2 receives data for a short data burst and, as slot 16 is also a PLMN boundary slot, performs a CCA check of unlicensed carrier 80. However, because of the data transmission from TX 1 on unlicensed carrier 80, the CCA check fails and TX 2 is blocked from transmission until the next PLMN boundary where the channel is clear. At slot 17, TX 3 receives data for transmission and, at the next PLMN boundary, at slot 18, TX 3 performs an unsuccessful CCA check, blocked by the transmission from TX 1. Each of TXs 2 and 3 perform ECCA checks at the subsequent PLMN boundaries at slots 18 (TX 2) and 21 (TXs 2 and 3). Because TX 1 continues transmitting the data burst through the PLMN boundary at slot 21, the subsequent ECCA checks at slots 18 and 21 fail for TXs 2 and 3.

At the next PLMN boundary, at slot 25, the ECCA checks by TXs 2 and 3 detect that unlicensed carrier 80 is now clear, and TXs 2 and 3 each begin transmission of their data bursts. Transmission by TXs 2 and 3 stops at the PLMN gap, at slot 27. However, because each of TXs 2 and 3 still have data to transmit, the next ECCA check occurs at the next PLMN boundary of the following transmission frame, at slot 2. TXs 2 and 3 detect that unlicensed carrier 80 is clear at slot 2 and begin their transmissions again.

At the PLMN boundary at slot 6, TX 1 receives data and performs a CCA check. The CCA check fails as both TXs 2 and 3 are transmitting on unlicensed carrier 80. TX 1 then performs ECCA checks at the subsequent PLMN boundaries of slots 10 and 13. The data of TX 2 finishes transmitting at slot 6, while the data of TX 3 finishes at slot 7. Because slot 6 is a designated PLMN boundary, TX 2 stops all transmission at slot 6. However, because slot 7 is not a designated PLMN boundary, eNB 3 adds padding to continue transmitting on unlicensed carrier 80 through the next PLMN boundary at slot 10. At slot 13, TX 1 detects that unlicensed carrier 80 is clear, in response to the ECCA check, and begins transmission of its next data burst.

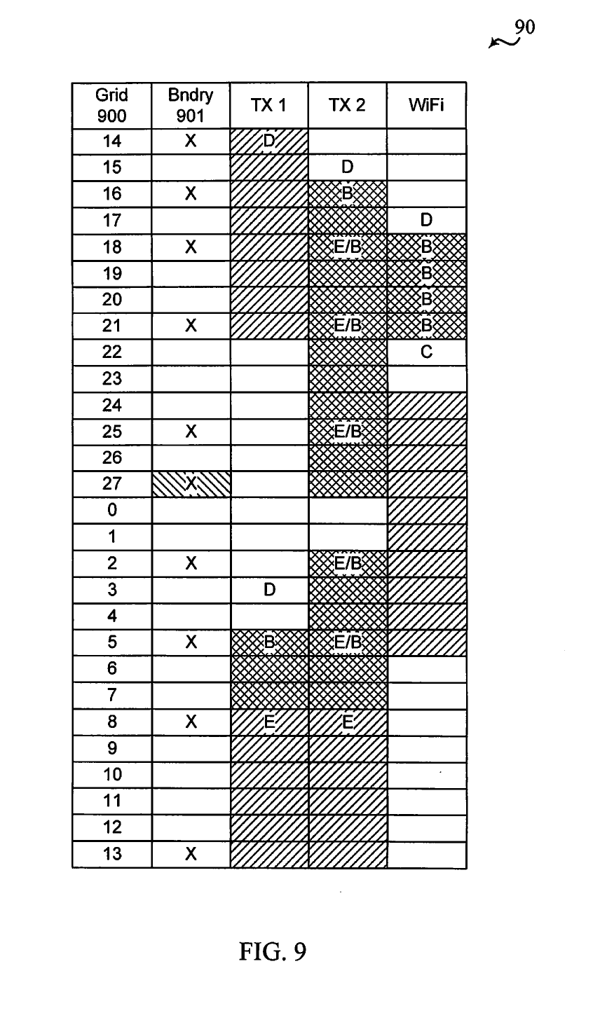

FIG. 9 is a block diagram illustrating an unlicensed carrier 90 shared by multiple transmitting nodes configured according to one aspect of the present disclosure. PLMN grid 900 identifies the sequence of slots for transmission over unlicensed carrier 90 by TXs 1-2. PLMN boundary 901 identifies each of the PLMN boundaries and the PLMN gap scheduled for transmissions according to the various aspects. As illustrated, TXs 1-2 also compete with a WiFi transmitter, WiFi 1, for unlicensed carrier 90. Because WiFi 1 does not follow the same PLMN boundary and gap procedures, it may attempt to gain access to unlicensed carrier 90 at any time.

At slot 17, WiFi 1 obtains data and is ready to transmit. WiFi 1 performs an LBT procedure at slot 18, attempting to gain access to unlicensed carrier 90. However, TX 1 is transmitting a data burst on unlicensed carrier 90 at slot 18. TX 2 receives data at slot 15 and performs a CCA check at the next available PLMN boundary at slot 16, which fails because of the transmissions from TX 1. TX 2 then unsuccessfully performs ECCA checks at subsequent PLMN boundaries, at slots 18 and 21. Because WiFi 1 may attempt to access unlicensed carrier 90 at any time, WiFi 1 continues monitoring the traffic on unlicensed carrier 90 at slots 18-22. At slot 22, WiFi 1 finally detects that unlicensed carrier 90 is clear. After waiting for a specific backoff time from detecting the clear channel, WiFi 1 begins transmitting data on unlicensed carrier 90 at slot 24.

When TX 2 unsuccessfully performs an ECCA check at slot 21, the next available PLMN boundary for the next ECCA check is at slot 25. At this ECCA check, TX 1 has finished transmissions. However, WiFi 1 began transmissions on unlicensed carrier 90 at slot 24. Therefore, the ECCA check by TX 2 will fail again. The next available PLMN boundary that TX 2 can perform an ECCA check is slot 2 of the next transmission frame. However, because WiFi 1 is not subject to the end of transmission directive at the PLMN gap of slot 27, WiFi 1 continues to transmit at slots 2 and 5. Therefore, the ECCA checks of TX 2 at slot 2 and 5 will again fail. At slot 8, the next PLMN boundary, both eNB 2 and TX 1, which obtained data for transmission at slot 3 and detected a failed CCA check at slot 5 as well, detect a clear ECCA check and begin transmitting data on unlicensed carrier 90. Here, with contention between TXs 1 and 2, configured according to the example aspect of the present disclosure, and WiFi 1, which is not subject to the same rules, the transmitting nodes in the PLMN do not automatically get to the reuse level 1 after the scheduled PLMN gap. However, TXs 1 and 2 are able to secure access to unlicensed carrier 90 soon after WiFi 1 ceases data transmission.

FIG. 10 is a functional block diagram illustrating example blocks executed to implement one aspect of the present disclosure. At block 1000, a transmitter receives data for transmission over an unlicensed carrier. In response to receiving the data, the transmitter calculates, at block 1001, a next available ECCA opportunity for the unlicensed carrier. For example, all transmitters within the same PLMN may calculate the all available PLMN boundaries using system information, such as the PLMN ID and the system time, and a pseudo-random number that designates the number of PLMN slots until the next opportunity.

At block 1002, the transmitter performs a CCA check on the unlicensed carrier at the next available ECCA opportunity. A determination is then made, at block 1003, whether the CCA check is clear or not. If the transmitter detects a clear CCA, then, at block 1004, the transmitter transmits channel reserving signals onto the unlicensed carrier. The channel reserving signals may include CUBs, the transmitted data, and any padding signals added by the transmitter if the data for transmission runs out before the next ECCA opportunity, such as before the next scheduled PLMN boundary. If the transmitter detects transmissions on the unlicensed carrier in response to the determination at block 1003, then, the transmitter will again, at block 1001, calculate the next available ECCA opportunity on the unlicensed carrier.

Various aspects of the present disclosure provide for design of synchronous load based equipment for operations in LTE/LTE-A networks with unlicensed spectrum. The various design aspects preserve LTE OFDM symbol duration, which may be various durations, such as 1/14 ms, 1/12 ms, and the like, and add ½ symbol for CUBS and CCA. The LTE frame structure may also be preserved with a granularity of 2, 5 or 10 ms using a corresponding q parameter of 5, 12 or 24. The various aspects of load based equipment outperform WiFi by achieving a reuse factor of 1 at each PLMN gap. The various aspects of load based equipment also outperform frame based equipment through a much lower latency. Thus, in such load based equipment designs, the compatible transmitter may reserve idle carriers at any moment without necessity of a CCA period, as defined in a fixed frame. Moreover, the load based equipment in LTE/LTE-A networks with unlicensed spectrum may perform short burst transmission that does not prevent other nodes from also reserving the channel.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 6 and 10 may comprise processors, electronics devices, hardware devices, electronics components, logical circuits, memories, software codes, firmware codes, etc., or any combination thereof

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) and any combinations thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
receiving, at a transmitter, data for transmission over an unlicensed carrier;
calculating, at the transmitter, a first available extended clear channel assessment (ECCA) opportunity of the unlicensed carrier after the receiving, wherein the calculating uses at least network information and a pseudo-random number;
performing a clear channel assessment (CCA) check, by the transmitter, on the unlicensed carrier at the first available ECCA opportunity;
in response to detecting a clear CCA check, transmitting channel reserving signals, by the transmitter, onto the unlicensed carrier; and
in response to failing to detect the clear CCA check, calculating, by the transmitter, a next available ECCA opportunity of the unlicensed carrier using at least the network information and another pseudo-random number.

2. The method of claim 1, wherein the channel reserving signals include at least one of:
a channel usage beacon signal (CUBS);
transmission of the data; or
transmission of signal padding after the transmission of the data, wherein the signal padding is transmitted until the next available ECCA opportunity.

3. The method of claim 1, wherein each of the first available ECCA opportunity and the next available ECCA opportunity is determinable by each transmitting node in a network.

4. The method of claim 1, further including:
ending the transmitting of the channel reserving signals at one of:
a next available ECCA opportunity after all of the data has been transmitted; or
a predetermined network gap.

5. The method of claim 1, wherein the network information includes at least one of:
a public land mobile network (PLMN) identifier; or
a system time.

6. The method of claim 1, wherein a CCA slot time is set to one-half of an orthogonal frequency division multiplex (OFDM) symbol.

7. The method of claim 6, further including:
selecting a contention parameter based on a desired maximum burst duration and a desired contention window size, wherein the desired contention window size is a function of the CCA slot time and the contention parameter.

8. The method of claim 1, wherein the transmitter includes one of: a base station or a mobile device.

9. An apparatus configured for wireless communication, comprising:
means for receiving, at a transmitter, data for transmission over an unlicensed carrier;
means for calculating, at the transmitter, a first available extended clear channel assessment (ECCA) opportunity of the unlicensed carrier after the means for receiving, wherein the means for calculating uses at least network information and a pseudo-random number;
means for performing a clear channel assessment (CCA) check, by the transmitter, on the unlicensed carrier at the first available ECCA opportunity;
means, executable in response to detecting a clear CCA check, for transmitting channel reserving signals, by the transmitter, onto the unlicensed carrier; and
means, executable in response to failing to detect the clear CCA check, for calculating, by the transmitter, a next available ECCA opportunity of the unlicensed carrier using at least the network information and another pseudo-random number.

10. The apparatus of claim 9, wherein the channel reserving signals include at least one of:
a channel usage beacon signal (CUBS);
transmission of the data; or
transmission of signal padding after the transmission of the data, wherein the signal padding is transmitted until the next available ECCA opportunity.

11. The apparatus of claim 9, wherein each of the first available ECCA opportunity and the next available ECCA opportunity is determinable by each transmitting node in a network.

12. The apparatus of claim 9, further including:
means for ending the transmitting of the channel reserving signals at one of:
a next available ECCA opportunity after all of the data has been transmitted; or
a predetermined network gap.

13. The apparatus of claim 9, wherein the network information includes at least one of:
a public land mobile network (PLMN) identifier; or
a system time.

14. The apparatus of claim 9, wherein the transmitter includes one of: a base station or a mobile device.

15. A computer program product for wireless communications in a wireless network, comprising:
a non-transitory computer-readable medium having program code recorded thereon, the program code including:
program code for causing a computer to receive, at a transmitter, data for transmission over an unlicensed carrier;
program code for causing the computer to calculate, at the transmitter, a first available extended clear channel assessment (ECCA) opportunity of the unlicensed carrier after execution of the program code to receive, wherein the program code to calculate uses at least network information and a pseudo-random number;
program code for causing the computer to perform a clear channel assessment (CCA) check, by the transmitter, on the unlicensed carrier at the first available ECCA opportunity;
program code, executable in response to detecting a clear CCA check, for causing the computer to transmit channel reserving signals, by the transmitter, onto the unlicensed carrier; and
program code, in response to failing to detect the clear CCA check, for causing the computer to calculate, by the transmitter, a next available ECCA opportunity of the unlicensed carrier using at least the network information and another pseudo-random number.

16. The computer program product of claim 15, wherein the channel reserving signals include at least one of:
a channel usage beacon signal (CUBS);
transmission of the data; or
transmission of signal padding after the transmission of the data, wherein the signal padding is transmitted until the next available ECCA opportunity.

17. The computer program product of claim 15, wherein each of the first available ECCA opportunity and the next available ECCA opportunity is determinable by each transmitting node in a network.

18. The computer program product of claim 15, further including:
program code for causing the computer to end the transmission of the channel reserving signals at one of:
a next available ECCA opportunity after all of the data has been transmitted; or
a predetermined network gap.

19. The computer program product of claim 15, wherein the network information includes at least one of:
a public land mobile network (PLMN) identifier; or
a system time.

20. The computer program product of claim 15, wherein a CCA slot time is set to one-half of an orthogonal frequency division multiplex (OFDM) symbol.

21. The computer program product of claim 20, further including:
program code for causing the computer to select a contention parameter based on a desired maximum burst duration and a desired contention window size, wherein the desired contention window size is a function of the CCA slot time and the contention parameter.

22. The computer program product of claim 15, wherein the transmitter includes one of: a base station or a mobile device.

23. An apparatus configured for wireless communication, the apparatus comprising:
at least one processor; and
a memory coupled to the at least one processor,
wherein the at least one processor is configured:
to receive, at a transmitter, data for transmission over an unlicensed carrier;
to calculate, at the transmitter, a first available extended clear channel assessment (ECCA) opportunity of the unlicensed carrier after the reception, wherein the configuration to calculate uses at least network information and a pseudo-random number;
to perform a clear channel assessment (CCA) check, by the transmitter, on the unlicensed carrier at the first available ECCA opportunity;
to transmit channel reserving signals, by the transmitter, onto the unlicensed carrier in response to detecting a clear CCA check; and
to calculate, by the transmitter, a next available ECCA opportunity of the unlicensed carrier using at least the network information and another pseudo-random number in response to failing to detect the clear CCA check.

24. The apparatus of claim 23, wherein the channel reserving signals include at least one of:
a channel usage beacon signal (CUBS);
transmission of the data; or
transmission of signal padding after the transmission of the data, wherein the signal padding is transmitted until the next available ECCA opportunity.

25. The apparatus of claim 23, wherein each of the first available ECCA opportunity and the next available ECCA opportunity is determinable by each transmitting node in a network.

26. The apparatus of claim 23, further including configuration of the at least one processor to end the transmission of the channel reserving signals at one of:
a next available ECCA opportunity after all of the data has been transmitted; or
a predetermined network gap.

27. The apparatus of claim 23, wherein the network information includes at least:
a public land mobile network (PLMN) identifier; and
a system time.

28. The apparatus of claim 23, wherein a CCA slot time is set to one-half of an orthogonal frequency division multiplex (OFDM) symbol.

29. The apparatus of claim 28, further including configuration of the at least one processor to select a contention parameter based on a desired maximum burst duration and a desired contention window size, wherein the desired contention window size is a function of the CCA slot time and the contention parameter.

30. The apparatus of claim 23, wherein the transmitter includes one of: a base station or a mobile device.
